(19) United States
(12) Patent Application Publication
(10) Pub. No.: US 2023/0400976 A1
(43) Pub. Date: Dec. 14, 2023

(54) Portable Information Terminal Device

(71) Applicant: Kei OSUMI, Shinjuku-ku (JP)

(72) Inventor: Kei OSUMI, Shinjuku-ku (JP)

(21) Appl. No.: 17/956,997

(22) Filed: Sep. 30, 2022

(30) Foreign Application Priority Data
Jun. 10, 2022 (JP) 2022-094751

(51) Int. Cl. G06F 3/0485; G06F 3/04883

(52) U.S. Cl. CPC G06F 3/0485; G06F 3/04883

(57) ABSTRACT

A portable information terminal device is provided having a display screen, a function of displaying a data on the display screen and a function of viewing and editing the data, the device having an operation element that is displayed on the display screen and operates the display of the data, and a function of scrolling the data displayed-on the display screen up and down the display screen by an operation of the operation element, and a function of writing or adding a new data at an arbitrary position of the display screen by an operation of the operation element. Furthermore, the present invention is the portable information terminal device having a function of displaying a mark on the display screen when the operation element is touched, wherein new data can be written or added on the display screen by using the mark.

### CROSS REFERENCE TO RELATED APPLICATIONS

This application claims priority from Japanese Patent Application number JP 2022-094751 filed on Jun. 10, 2022, which is hereby incorporated by reference herein in its entirety.

### TECHNICAL FIELD

The present invention relates to applications and functions of writing or adding new data on a display screen of a portable information terminal device.

### BACKGROUND ART

In portable information terminal devices such as a smartphone, multiple character data and image data arranged vertically in a display screen of the portable information terminal devices are viewed and edited. FIG. 13 is a figure showing an example of an application that allows users to view, edit, and add multiple data conventionally used in the smartphone. When this application is started, the display shown in FIG. 13 appears on the display screen 51 of the smartphone. In FIG. 13, a button 52, which is an operation element, is arranged at the lower part of the screen 51, and data 53 (53-1, 53-2, 53-3) are shown at the upper part of the screen 51. When the button 52 is touched, the keyboard for input is displayed in the screen and new data can be written and added. However, the new data can always only be written and added at the top of the display screen 51, i.e., only directly above the data 53-3 (<CCC . . . >). (See https://play.google.com/store/apps/details?id=com.google.android.apps.tasks)

Since the conventional button is only used for touching, there is a problem that new data can be written or added only at a predetermined position such as the top or bottom of a vertically arranged data or data row. To place data at any position in the display screen, new data must be written or added at a predetermined position and then moved to a desired position. For example, in the example shown in FIG. 13, since the data added at the top is selected and then moved to the desired position, it is troublesome, laborious, and time-consuming. If the data to be added is long or the list of data is long, it will be very time-consuming, there is also the problem that thinking is not organized because the list is traced back each time an input is executed.

### SUMMARY

The present invention relates to a data control function of a display screen in a portable information terminal device such as a smartphone having a display screen with a touch sensor function. The present invention provides a function of writing, describing or adding new data to the data displayed on the display screen by an easy and simple operation. The present invention has the following features.
(1) The present invention is a portable information terminal device (or a portable information terminal device equipped with an application (software)) having a display screen, a function of displaying a data on the display screen and a function of viewing and editing the data, the device having an operation element that is displayed on the display screen and operates the display of the data, and a function of scrolling the data displayed on the display screen up and down the display screen by an operation of the operation element, and a function of writing or adding a new data at an arbitrary position of the display screen by an operation of the operation element. Furthermore, the present invention is the portable information terminal device (or the portable information terminal device equipped with an application (software)) having a function of displaying a mark on the display screen when the operation element is touched, wherein new data can be written or added on the display screen by using the mark.
(2) The present invention is, in addition to the above (1), the portable information terminal device (or the portable information terminal device equipped with an application (software)) having a function of placing the mark directly above or below the data when a data is displayed on the display screen, and the portable information terminal device (or a portable information terminal device equipped with an application (software)) having a function of placing the mark between two data when said two data are displayed vertically and side by side on the display screen.
(3) The present invention is, in addition to the above (1) and/or (2), the portable information terminal device (or the portable information terminal device equipped with an application (software)) having a function of dragging the operation element up and down on the display screen while the operation element being touched, and furthermore the portable information terminal device having a function of moving the mark in the direction that the operation element drags on the display screen, and furthermore the portable information terminal device (or the portable information terminal device equipped with an application (software)) having a function of placing the mark directly above or below a data when the data is displayed on the display screen, or a function of placing the mark between two data when two data are displayed vertically and side by side on the display screen.
(4) The present invention is, in addition to the above (1) and/or (2) and/or (3), the portable information terminal device (or the portable information terminal device equipped with an application (software)) having a function of stopping the operation element and a function of scrolling the data downward on the display screen when the operation element reaches a predetermined position at the top of the display screen. Furthermore, if a data exists outside the top of the display screen, the present invention is the portable information terminal device (or the portable information terminal device equipped with an application (software)) having a function of displaying the data existing outside on the display screen by the function of scrolling the data.
(5) The present invention is, in addition to the above (1) and/or (2) and/or (3) and/or (4), the portable information terminal device (or the portable information terminal device equipped with an application (software)) having a function of stopping the operation element and a function of scrolling the data upward on the display screen when the operation element reaches a predetermined position at the bottom of the display screen. Furthermore, if a data exists outside the bottom of the display screen, the present invention is the portable information terminal device (or the portable information terminal device equipped with an application (software)) having a function of displaying the data existing outside on the display screen by the function of scrolling the data.
(6) The present invention is, in addition to the above (1) and/or (2) and/or (3) and/or (4) and/or (5), the portable information terminal device (or the portable information terminal device equipped with an application (software)) having a function of writing or adding a new data at the position where the mark is placed by releasing the touch from the operation element.
(7) The present invention is, in addition to the above (1) and/or (2) and/or (3) and/or (4) and/or (5) and/or (6), the portable information terminal device (or the portable information terminal device equipped with an application (software)) having a function of displaying a keyboard on the display screen by releasing the touch from the operation element and a function of writing or adding a new data with the keyboard at the position where the mark is placed.

### Advantageous Effect of the Invention

According to the present invention, new data can be written, described or added at any desired position in the display screen by an easy and simple operation of one operation of an operation element such as a button or the like. A position to write, describe or add new data can be designated by a simple operation of touching an operation element to make a mark (cursor, etc.) appear at a predetermined position. Further, the mark can be moved to an arbitrary position in the displayed data by moving the operation element up and down in the display screen while touching the operation element, and new data can be written or added at any position in the displayed data with a very simple operation. By bringing the operation element to a predetermined position at the top or bottom of the display screen and scrolling the data in the display screen downward or upward, data outside the top or bottom edge of the display screen can also be brought into the display screen. Accordingly, new data can be written or added very easily at an arbitrary position of data outside the display screen. Since the position to write, add or insert a new data can be determined before the new data is created, the time required to move data can be shortened, and long data lists do not pose a problem. In addition, since there is no need to go back through the data list each time an input is executed, there is no problem that thinking is not organized

### BRIEF DESCRIPTION OF THE DRAWINGS

FIG. 1 is a block diagram showing the schematic functions of the portable information terminal device of the present invention.

FIG. 2 is a diagram showing multiple rows of data vertically aligned in the data display screen of a smartphone.

FIG. 3 is a diagram showing the state of the data display screen of the smartphone when the button is touched (with a finger, touch pen, or the like).

FIG. 4 is a diagram for explaining a button drag operation within the data display screen of the smartphone.

FIG. 5 is a diagram showing a method of moving data outside the top edge of the data display screen into the data display screen.

FIG. 6 is a diagram showing a flowchart for explaining an example of the data addition processing method of the present invention.

FIG. 7 is a diagram showing a display screen displayed by activating the application of the present invention.

FIG. 8 is a diagram showing a display screen immediately after touching or pressing the button with a finger, etc.

FIG. 9 is a diagram showing a display screen in which the button is dragged to move the button upward on the data display screen.

FIG. 10 is a diagram showing a data input screen displayed on the display screen when the touch is released from the button.

FIG. 11 is a diagram showing a display screen after the input is executed.

FIG. 12 is a diagram showing a state in which the button is moved to the upper end of the data display screen while the button is touched.

FIG. 13 is a diagram showing an example of an application conventionally used in a smart phone with which a plurality of data can be browsed and edited.

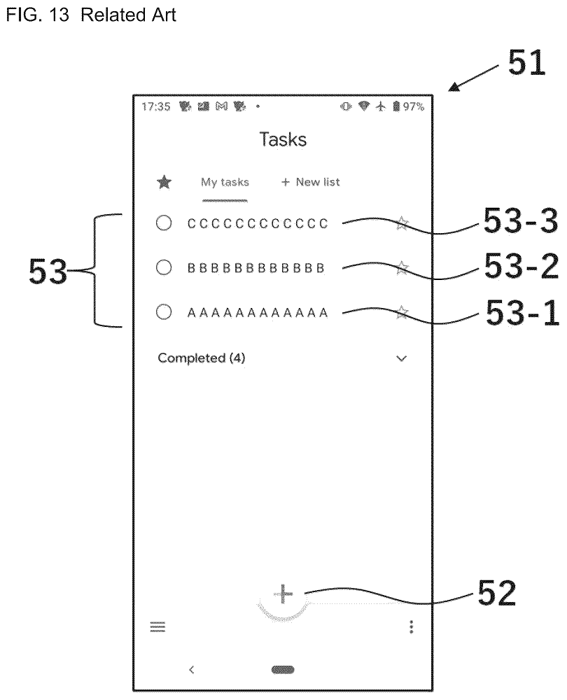

FIGS. 14(a)-(c) are diagrams explaining the operation of the present invention when the number of displayed data is small.

FIGS. 15(a)-(c) are diagrams illustrating how the present invention works when the button reaches the top edge of the smartphone's data display screen.

FIGS. 16(a)-(c) are diagrams illustrating how the present invention works when the button reaches the bottom edge of the smartphone's data display screen.

### DETAILED DESCRIPTION

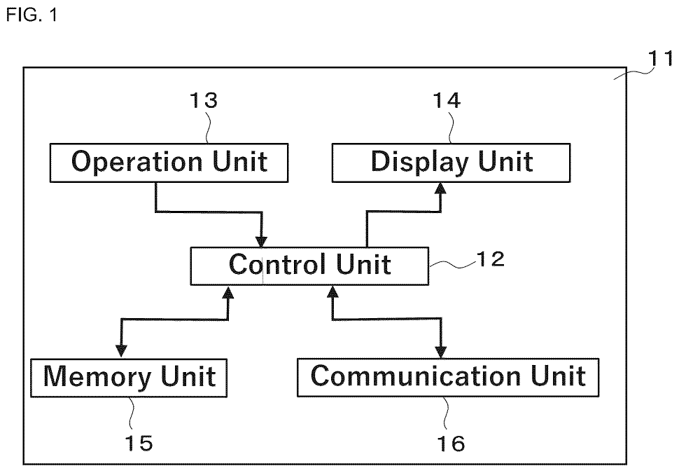

This invention provides a function to easily add new data to data displayed on a display screen or to easily write or describe or add on a display screen in portable information terminal devices such as smartphones, portable game consoles, tablet terminals, or media players that have touch screen displays (or referred to as display screens). That is, the portable information terminal device of the present invention is equipped with an application (software) for executing various functions. And using their functions, new data is simply written or added to the data displayed on the display screen. FIG. 1 is a block diagram showing a schematic system of the portable information terminal device used in the present invention. Alternatively, FIG. 1 may be called a block diagram showing a schematic system of the application (software) installed in the portable information terminal device. The portable information terminal device 11 mainly comprises a control unit 12, an operation unit 13, a display unit 14, a memory unit 15, and a communication unit 16. The display unit 14 comprises a view (display) of a display screen, for example, data such as characters and images and operation elements such as buttons and icons (e.g., GUI (Graphical User Interface)). The display screen is a liquid crystal display screen, or an organic EL (Electro Luminescence) display screen, and the view of the display screen is displayed on the display screen according to the commands of the control unit 12. The operation unit 13 comprises a touch sensor of various types, and detects a contact of an operator's finger, touch pen, or the like with the display screen of the display unit 14. The contact signal is sent to the control unit 12 as an operation input. The operation element (or also referred to as a manipulator or an actuator) can also be moved up and down in the display screen by a command of the control unit 12 in response to the operator's drag operation, which is an operation of tracing the display screen while touching the operation element on the display screen.

The control unit 12 comprises a microprocessor such as a CPU (Central Processing Unit) or a GPU (Graphics Processing Unit), which operates according to a program stored in the memory unit 15 to give commands to each unit of the portable information terminal device and control it. For example, the control unit 12 gives commands to the display unit 14 in response to an operation input of the operation unit 13 to display various views on the display screen or to control an operation of the display. Also, the control unit 12 gives commands to the display unit 14 with information from the memory unit 15 or the communication unit 16 in response to an operation input of the operation unit 13 to perform various views on the display screen or to control an operation of the display. The memory unit 15 is, for example, an IC memory and stores various information used by the information terminal device 11. Also, the memory unit 15, for example, stores programs for functioning the control unit 12, and the memories stored in the memory unit 15 are played back as needed by commands of the control unit 15. The communication unit 16 has the function to acquire information from the outside and to transmit information to the outside through various communication methods. For example, an application software for executing the invention on the portable information terminal device 11 can be downloaded through the communication unit 16. External information can be obtained by the communication unit 16 and stored by the memory unit 15 and displayed on the display screen by the display unit 14, under the control of the control unit 12.

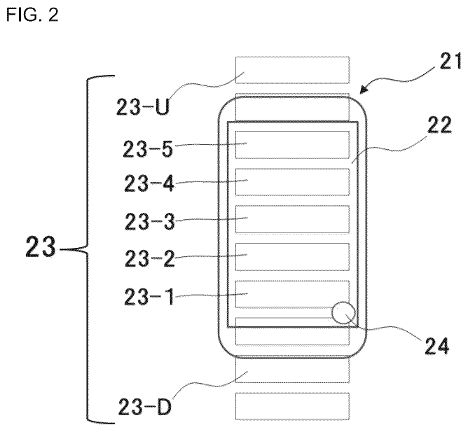

When the application (software) of the present invention is launched, data of text and image, etc. or a list of data consisting of such data (or referred to simply as data, or data string or data row) appear on the display screen of the portable information terminal device such as a smartphone, and buttons and other also operation elements, which are also hereafter referred to simply as buttons or button, also appears on the display screen. When the application is launched, the button is usually located on the bottom right side of the screen, but the location of the button on the screen need not be limited. FIG. 2 shows a plurality of data (rows) arranged vertically (in the vertical direction) in the display screen 22 of a smartphone 21. Here, the vertical direction is usually the longitudinal direction of the substantially rectangular-shaped display screen 22, but it may also be the short side direction when the display screen 22 of the smartphone 21 is placed horizontally. When the application of the invention is started on the smartphone 21, a number of data (rows), which are data 23-1, 23-2, 23-3, 23-4, 23-5, etc., are displayed in the display screen 22. Launching the application can be performed from the normal selection of the application on the Smartphone 21. This application software may be obtained externally through the communication unit 16, or it may be once stored in the memory unit 15 after it is obtained externally.

Data are, for example, characters, text, graphics, images, etc. Data also include groups of individual data, for example, text, descriptions, images and their descriptions, etc. Data string(s) or data row(s) are series of data, which may also be referred to simply as data. In addition to data, an operation element 24 such as a button is also displayed to operate in the display screen. In FIG. 2, a button 24 is displayed between the data in the lower right corner of the vertically long display screen 22, but it may be displayed in any other position in the display screen. FIG. 2 also shows that data also exists outside of the display screen 22. For example, data 23-U is located outside of the top edge or upper end of the screen 22 and data 23-D is located at outside of the bottom edge or lower end of the screen 22. However, the data is not actually visible outside of the screen 22. That is, it means that there are also data after data 23-1 and before data 23-5 in addition to the data present in the screen (23-1 to 23-5). The data displayed on the screen 22 and the data existing outside of the screen 22 are stored in the memory unit 15, and their data are displayed on the display unit 14 under the command of the control unit 12. Naturally, if there is no data before data 23-5 or after data 23-1 in the memory unit 15, no data exists outside the top or bottom edge of the display screen 22.

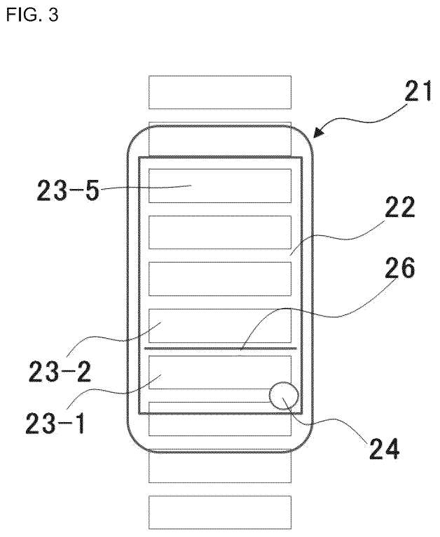

FIG. 3 shows the display screen of the smartphone 21 at the time when the button 24 is touched with a finger, stylus, etc. When this button 24 is touched with a finger, etc., a cursor 26, which is shown by a straight line, appears directly above the data 23-1 above the button 24 at the time of touch, that is, it is displayed between data 23-1 and data 23-2, and directly above data 23-1 at the top of data 23-1 closest to the button 24 in FIG. 3. Although shown here with a cursor, it may also be a pointer, various markings, or other marks including cursors. Touching the button 24 is detected by the operation unit 13, which sends the signal to the control unit 12. The control unit 12 pulls mark information such as the cursor from the memory unit 15 and commands the display unit 14 to display the mark 26 such as the cursor on the screen 22 at a predetermined position.

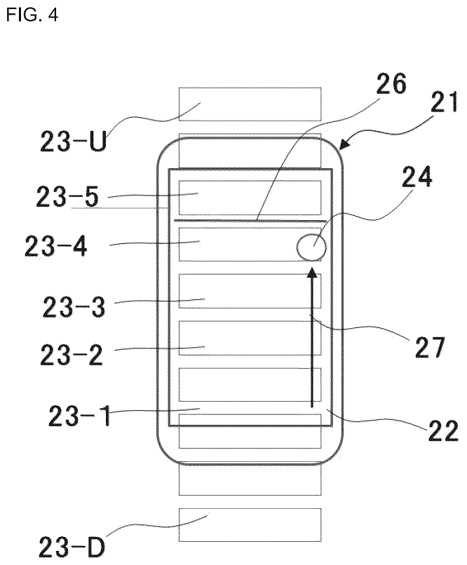

FIG. 4 is a diagram illustrating a button drag operation on the display screen 22 of the smartphone 21. The button 24 can be moved in the screen 22 from the lower end to the upper end of the screen 22 by the drag operation. This drag operation is an operation of moving the button 24 up and down on the display screen 22 by moving the finger or the like on the display screen 22 while touching the button 24 with a finger or the like. The state of the drag is indicated by an upward arrow 27. Also, by this operation, the position of the cursor 26 also moves at the same time as the button 24 while maintaining the positional relationship with the button 24, for example, cursor 26 is placed directly above the data closest to the button 24. Thus, by the operation or manipulation of the operation element, the present invention has a function of moving the mark in the direction that the operation element drags on the display screen. That is, by this drag operation, the cursor 26 can be moved to an arbitrary position of the data displayed on the screen 22 or to an arbitrary position on the screen 22, and the position to write or add the data can be determined as shown later. As described above, the cursor 26 can be placed not only between data groups or between data columns, but also between individual data, for example, between data lines. If the above is stated briefly, in the present invention, it may be said that the cursor 26 can be placed directly above the data, directly below the data, or between the data by dragging the operation element such as the button. Since moving a finger or the like while touching the button 24 with it can be detected by a touch sensor or the like, the operation unit 13 sends the signal such as position information or the like of the button 24 in the display screen 22 to the control unit 12. The control unit 12 receives the signal and commands the display unit 14 to move the button 24 along with the touch. As a result, the button 24 moves in the display screen 22. The control unit 12 also commands the display unit 14 that the cursor 26 should move simultaneously with the button 24 while maintaining the positional relationship between the cursor 26 and the button 24.

This cursor 26 can be used to write, describe, or add new data at any position or arbitrary position on the display screen. For example, if a data is displayed on the display screen, new data can be written, described, or added directly below or above the data, or between the data. In FIG. 4, after the cursor is moved by a drag operation to be placed between data 23-4 and data 23-5, when the touch of a finger or the like is released from the button 24, new data can be put in the position of cursor 26. For example, in the case of characters, new characters can be written at the position of the cursor by a character input operation of the smartphone. Alternatively, image data can also be inserted from the memory unit 15 or other external storage media through the communication unit 16. The operation unit 13 detects that the touch has been released from the button 24 by a touch sensor or the like and sends the signal to the control unit 12. The control unit 12 calls a data writing function or a new data addition function stored in the memory unit 15 and commands the display unit 14 to display the data. Using such the data writing function, etc., it is possible to perform the data writing such as character input and image insertion.

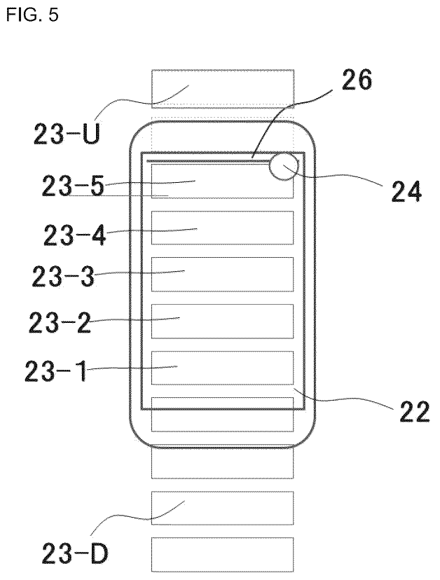

Data strings or data may exist outside of the display screen 22, as shown in FIG. 4. Data strings or data, 23-U, 23-D, etc., which exist outside of the top or bottom edges of the screen 22 as shown in FIG. 5, but these data strings or data can be moved within the screen 22. FIG. 5 is a diagram showing how to move the data outside the top edge of the screen within the screen. When the button 24 is moved to the top edge of the screen 22, that is, when Y coordinate, which indicates the vertical position in the screen 22, of the button 24 comes to the position of Y coordinate where the top edge of the screen 22 is arranged, the data displayed in the screen 22 scroll downward and the data strings or data such as 23-U, etc. existing outside of the top edge of the screen 22 move into the screen 22. If the positional relationship between the cursor 26 and the button 24 is maintained, the cursor 26 should not be visible when the button 24 comes to the top edge of screen 22. But the button 24 and the cursor 26 can be also set to be placed in approximately the same position by setting the cursor 26 to stay in near position of the top edge of the screen 22 when the button 24 comes to the top edge of screen 22. Alternatively, when the cursor 26 reaches the top edge of screen 22, the button 24 may not be moved and the data may be scrolled. Alternatively, by scrolling and moving the data displayed in the screen when the button 24 exceeds a predetermined position at the top of the screen, the data existing outside the screen at the start of the operation can be displayed within the screen and the position to write, describe or add new data can be specified above or below the data displayed in the screen.

Here, when data (e.g., 23-U) appears at the position (in the screen 22) where it should be added, new data can be added at the position of the cursor 26 above that data (e.g., 23-U) by releasing the finger from the button 24. To make the position of the cursor 26 easier to see, the button 24 may be moved slightly downward when the data (e.g., 23-U) appears in the screen 22. As a result, the cursor 26 may be present at the upper end of the data above the button 24, that is, at the original position of the cursor 26.

Similarly, when the button 24 moves and reaches the bottom edge of the screen 22, that is, when the Y coordinate, i.e., the vertical coordinate, of the button 24 comes to the Y coordinate position where the bottom edge of the screen 22 is placed, the data displayed on the screen scrolls upward and the data (columns) (e.g., 23-D) existing outside of the bottom edge of the screen 22 move into the display screen 22. In this case, the positional relationship between the button 24 and the cursor 26 remains unchanged. Alternatively, by scrolling and moving the data displayed in the screen, when the button 24 exceeds a predetermined position, i.e., predetermined Y coordinate, in the bottom portion of the screen, the data (for example, 23-D) existing outside the screen at the start of the operation can be displayed within the screen and the position to write, describe or add new data can be specified above or below the data displayed in the screen.

Here, when data (e.g., 23-D) appears at the position to be written or added, that is, at the position of the cursor 26 in the screen 22, new data can be added at the position of the cursor 26 above that data (e.g., 23-D) by releasing the finger from the button. Since the operation unit 13 detects the position information of the button 24 and sends the signal to the control unit 12, the fact that the button 24 has reached the top or bottom edge of screen 22 or a predetermined position in the screen 22 can be recognized by the control unit 12. As a result, the control unit 12 draws out the outside information of the screen 22 stored in the memory unit 15, and the control unit 12 then commands the display unit 14 to scroll the data (column) 23 (23-1 to 5, U, D, etc.) displayed vertically and side by side downward or upward in the screen 22 and to display the outside information such as 23-U, 23-D, etc. within the screen 22.

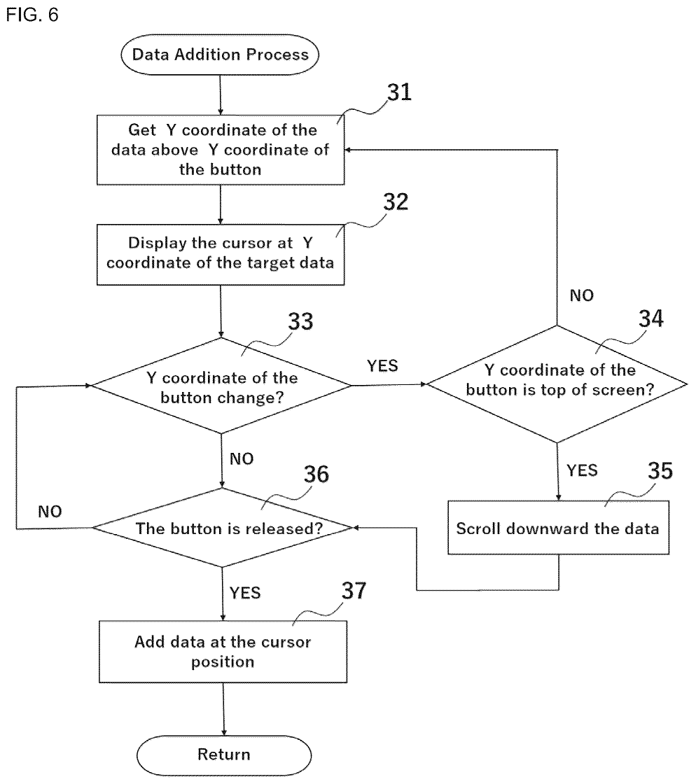

FIG. 6 shows a flowchart of an example of the data addition (or writing) processing method of the present invention. As described above, the Y coordinate of the data above the Y coordinate of the button which is the operation element displayed on the display screen of the smartphone is obtained. (Flow 31) Here, Y coordinate is a vertical coordinate of the screen. At the start, the button is usually placed at the bottom or near the bottom edge of the display screen and the data is placed on or underneath the button. When there is only one data, since the data is a target data, a cursor is displayed directly below the data in the screen. When there are multiple data, the cursor is displayed at the position of the Y coordinate directly below the target data, for example, the data closest to the button, by touching the button and/or moving the button. (Flow 32) The position of this cursor may be predetermined by the control unit 12 in relation to the position of the button.

Next, it is judged or determined whether there is a change in the Y coordinate of the button, which is the position in the vertical direction of the display screen. (Flow 33) Since the button can be dragged up and down in the screen while being touched, the Y coordinate of the button changes. If the Y coordinate of the button has not changed, it is judged or determined whether the button has not been touched, that is, the button has been released. (Flow 36) When the button is released, new data can be written, described or added at the position where the cursor is placed. (Flow 37) If the button is released here, for example, a keyboard is displayed on a part of the screen and new data can be written with the keyboard. Alternatively, new data can be inserted from the outside of the device. If more data is to be added, this flowchart is repeated. When there is a change in the Y coordinate of the button in Flow 33, it is judged or determined whether the Y coordinate of the button is at or near the upper end or the top edge of the screen. (Flow 34) If the Y coordinate of the button is not at or near the top edge of the screen, the process in the flow chart returns to Flow 31. If the Y coordinate of the button is at or near the top edge of the screen, the data is scrolled downward in the screen. (Flow 35) As a result, the data existing outside the upper end or top edge of the screen is displayed or appears on the screen. The process then enters Flow 36. If the button is not released, that is, the button is touched, in Flow 36, the process enters Flow 33 again. FIG. 6 shows the flowchart in the case where the button comes to the top edge of the screen. In the case where the button comes to the bottom edge of the screen, it is judged or determined whether the Y coordinate of the button is at the bottom edge in Flow 34, and the data is scrolled upward on the screen in Flow 35. Other flows are almost the same as the contents explained in FIG. 6.

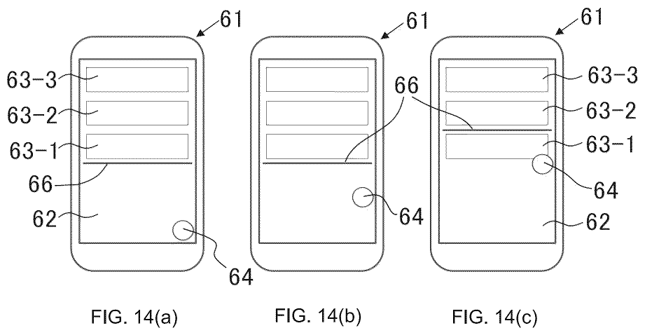

FIGS. 14(a)-(c) illustrate the operation of the invention when the number of data to be displayed is small. FIG. 14(a) shows the state of the screen immediately after touching the button after launching the application of the present invention. Three pieces of data or data rows (63: 63-1, 63-2, 63-3) are displayed at the upper position in the display screen 62 of the smartphone 61. That is, when the number of data (including data rows) is small, the data is displayed in order from the upper end or the top edge of the display screen 62. When the bottom of the data (63-1 to 3) is above the operation element, i.e., the button 64, the cursor 66 is displayed directly below the bottom data 63-1 of the data (63-1 to 3). FIG. 14(b) shows the state of the intermediate process when the button 64 is touched and dragged upward. If the button 64 is below the bottom data 63-1, the position of cursor 66 does not change. When the button 64 is dragged further upward and the button 64 reaches directly below the bottom data 63-1, the cursor 66 is moved and displayed immediately or directly above the bottom data 63-1 of the data (strings, or rows), that is, between the data 63-1 and the data 63-2, as shown in FIG. 14(c). This state is the position of the button and the cursor in the normal state, that is, when there are multiple data in the display screen, for example, the positional relationship between the button and the cursor in FIG. 3 (or FIG. 14(c)) is the normal state. The state in FIG. 14(c) indicates that the control unit 12 recognized that the Y coordinate of the button 64 in the display screen 62 has come to the same as or above the Y coordinate directly below the bottom data 63-1 of the data (rows) in the display unit 14, and that the control unit 12 commanded the display unit 14 to move the cursor 66 to a position directly above the bottom data 63-1 in the data sequence, that is, between the data 63-1 and the data 63-2.

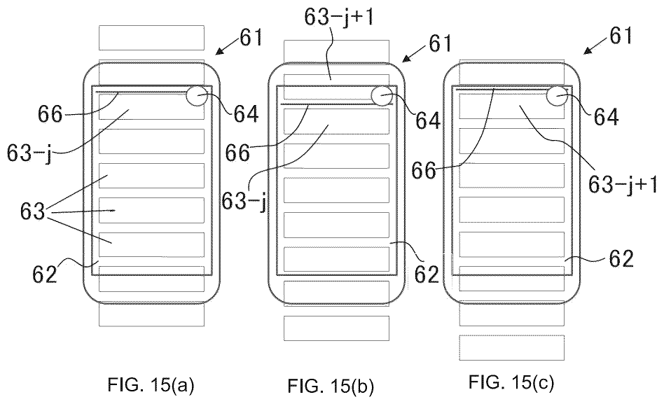

FIG. 15(a)-(c) are diagrams showing how the invention works when the button reaches the top edge or the upper end of the display screen of the smartphone. When the button 64 reaches the top edge or the upper end of the display screen 62 of the smartphone 61, the position of the button 64 is stopped, and the cursor 66 also is displayed directly above the top data 63-j displayed in the display screen 62, as shown in FIG. 15(a). Data 63 are then scrolled downwards in the display screen 62, and data 63-j+1 above data 63-j appears in the display screen 62. The cursor 66 is placed directly above the top data displayed on the screen. That is, the cursor 66 is between the data 63-j and the data 63-j+1, as shown in FIG. 15(b). When the data is scrolled further downward and all of the data 63-j+1 appear, the cursor 66 moves and is displayed directly above the data 63-j+1, as shown in FIG. 15(c). Thus, when the button reaches the top edge of the display screen, the data is scrolled downward, but the cursor is always positioned directly above the topmost data displayed within the display screen. This can be accomplished by the control unit 12 determining the position coordinates of the cursor from the Y coordinates of the buttons displayed in the display unit 14 and the Y coordinates of the topmost data displayed within the display screen and by the control unit 12 commanding to the display unit 14.

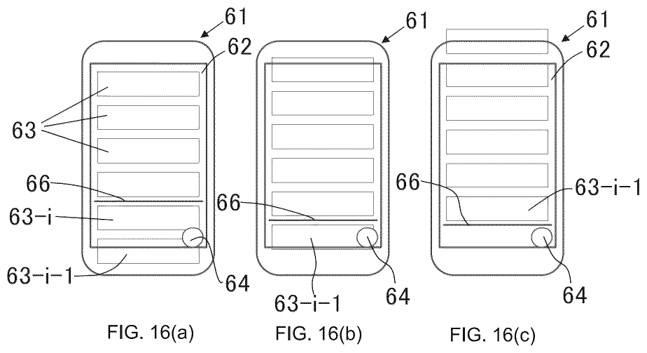

FIGS. 16(a)-(c) are diagrams showing how the invention works when the button reaches the bottom edge or the lower end of the display screen of the smartphone. When the button 64 reaches the bottom edge or the lower end of display screen 62 and the button 64 stops moving, the cursor 66 is placed directly above data 63-i on the button 64, as shown in FIG. 16(a). In this time, even if data 63-i−1, which is below data 63-i, is either outside the bottom edge of the display screen 62, or the top of data 63-i−1 appears in the display screen 62 and part of the button 64 overlaps part of data 63-i−1, the cursor 66 is located directly above the data 63-i while a portion of the button 64 is placed on a portion of the data 63-i above the data 63-i−1. The data 63 then scrolls upward in the display screen 62, and the data 63-i−1 below the data 63-i appears within the display screen 62. When the top or upper portion of the button 64 comes within the data 63-i−1 below the data 63-i, the cursor 66 is moved and placed directly above the data 63-i−1. That is, the cursor 66 is located between the data 63-i and the data 63-i−1, as shown in FIG. 16(b). Even when there is no data below the data 63-i−1, the data 63 scrolls further upward in the display screen 62, and when the bottom edge of the data 63-i−1 comes above the button 64, the cursor 66 is placed directly below the data above the button 64, i.e., the data 63-i−1, where scrolling also stops. The display unit 14 transmits to the control unit 12 that the Y-coordinate of the top of the button is now below the Y-coordinate of the bottom (edge) of the lowest data in the data (rows), and the control unit 12 commands the display unit 14 to place the cursor 66 directly below the bottom data in the data (rows). At the same time, the control unit 12 commands the display unit 14 to stop scrolling.

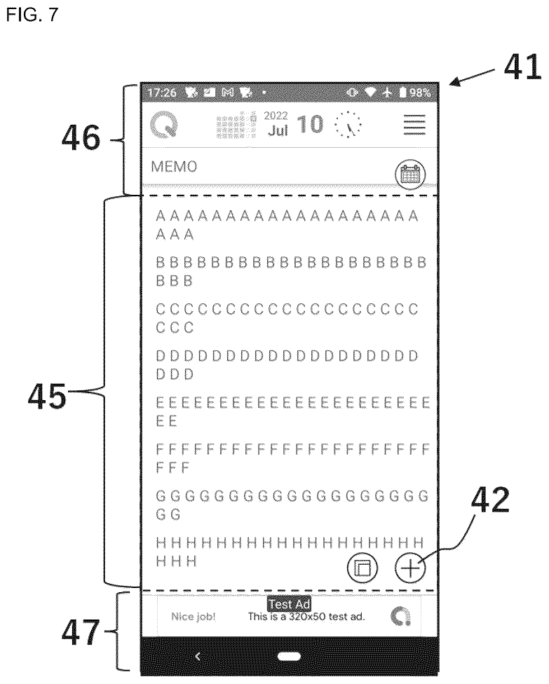

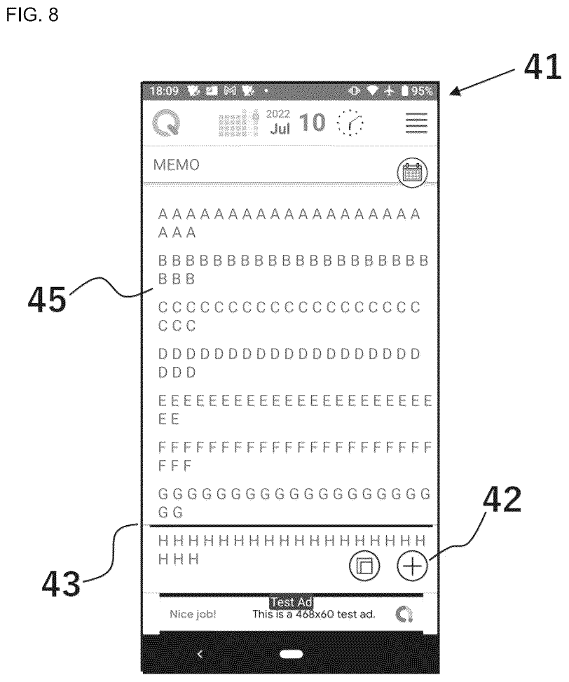

FIGS. 7 to 12 show examples of the invention. FIG. 7 shows the display screen 41 displayed after launching the application of the invention. The display screen 41 shown in FIG. 7 includes fixed or canned screens 46 and 47 for displaying predetermined contents and a data display screen 45 for allowing user to write, add, describe or edit various data. The boundaries between the canned screens 46 and 47 and the data display screen 45 is indicated by dashed lines. Therefore, since the display screens described so far (or above) in this specification mean data display screens, it should actually be described as data display screens. The data display screen can show various data, buttons, cursors, etc. A data (string) such as data <AAA . . . >, etc. and a button 42, etc. are displayed on the data display screen of the smartphone. The button 42 is located on the lower right portion of the data display screen 45. FIG. 8 is a diagram showing a display screen 41 immediately after a button 42 indicated by plus sign (+) is touched or pressed with a finger, etc. In the data display screen 45, a cursor 43 is displayed between the data <HHH . . . >located where the button 42 is placed and the data <GGG . . . >written above the data <HHH . . . >. When the finger touch is released from the button 42, new data can be written, described or added in the position of the cursor 43.

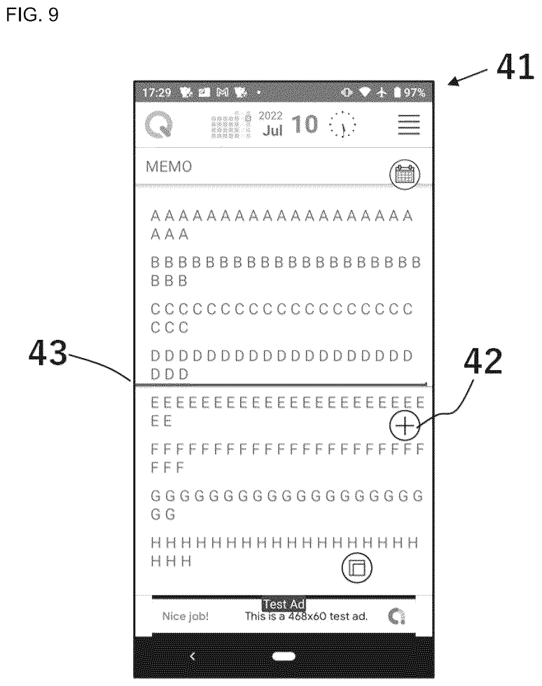

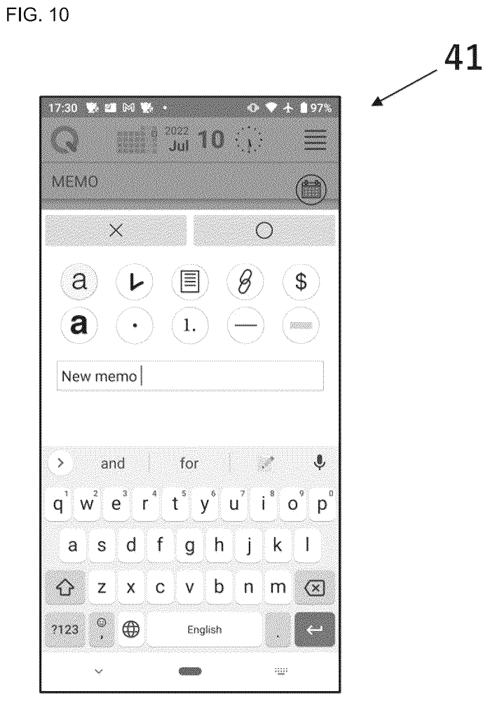

FIG. 9 is a diagram showing a state in which the button 42 is dragged to move upward in the data display screen 45. In the data display screen 45, the button 42 move from its previous location, for example, the location of the data <HHH . . . >in FIG. 8, to upper data <EEE . . . >, and the cursor 43 is placed between data <DDD . . . >and data<EEE . . . >. The cursor 43 also moves upward according to the position of the button 42. Here, when the finger touch is released from the button 42, new data can be written, described or added at the position of the cursor 43. FIG. 10 shows a data input screen displayed on the display screen when the finger touch is released from the button. Various keyboards for input are displayed on the display screen 41 of the smartphone. Using this keyboard, i.e., by touching the keys, etc., various characters and symbols, etc. can be entered. In FIG. 10, <New memo> is entered. In addition, an image or the like can also be inserted.

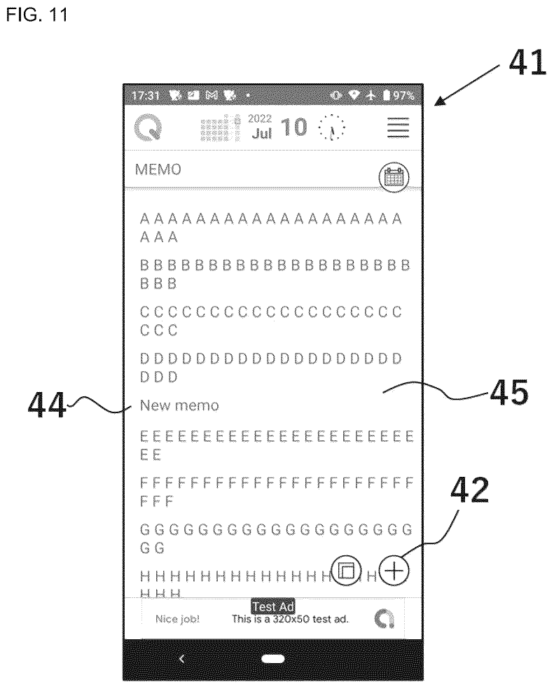

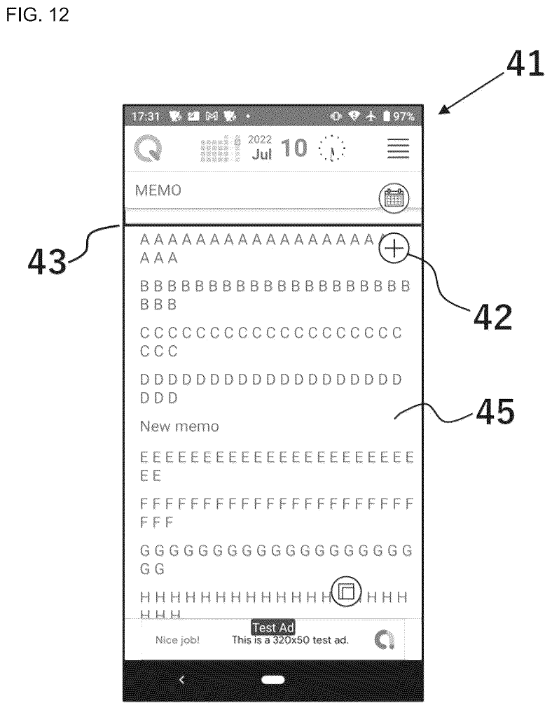

FIG. 11 shows the display screen after the input is executed. By executing the input, new data <New memo> is added at the position 44 where the cursor 43 was placed. Since the data addition is completed, the button 42 returns to the position when the application is started, that is, to the lower right position of the data display screen 45. Also, the cursor is not displayed in the data display screen. FIG. 12 is a diagram showing a state in which the button 42 is moved to or near the upper end or the top edge of the data display screen 45 while the button 42 is touched. The button 42 and the cursor 43 are stopped and displayed at or near the upper end position of the data display screen 41. If data exists above the data <AAA . . . >, the data in the data screen display scrolls downwards and the data above the data <AAA . . . >, that is, the data outside top edge of the data display screen appears and is displayed within the screen. And new data can be written, described or added directly above the displayed data. In other words, new data can be written, described or added at the cursor position. The method of adding data is the same as the procedure described above.

As described in detail above, using the functions of (the application (software) of) the present invention, new data can be easily written, described or added at any position in the data display screen or at an arbitrary position of data displayed on the data display screen of the portable information terminal device such as a smartphone. As a result, new data can be written, described or added at a desired position including an arbitrary position of data outside the screen, by a single operation. If a content described and explained in a certain part of the specification can be explained without contradiction in other part of the specification, it goes without saying that the content can be applied to the other part of the specification. Also, it goes without saying that the contents of the examples and embodiments described in the present application document can be used in combination with the contents of other examples and embodiments. Furthermore, it goes without saying that the embodiment is an example and can be modified in various ways without departing from the scope of the present invention, and the scope of rights of the present invention is not limited to the embodiments.

### INDUSTRIAL APPLICABILITY

The present invention can also be applied to other devices having a touch panel, for example, a personal computer, various measuring devices, and the like.

What is claimed is:

1. A portable information terminal device having a display screen, a function of displaying a data on the display screen and a function of viewing and editing the data, the device having:
an operation element that is displayed on the display screen and operates the display of the data;
a function of scrolling the data displayed on the display screen up and down the display screen by an operation of the operation element; and
a function of writing or adding a new data at an arbitrary position of the display screen by an operation of the operation element.

2. The portable information terminal device according to claim 1,
the device having a function of displaying a mark on the display screen when the operation element is touched, wherein new data can be written or added on the display screen by using the mark.

3. The portable information terminal device according to claim 2,
when a data is displayed on the display screen, the device having a function of placing the mark directly above or below the data.

4. The portable information terminal device according to claim 2,
when two data are displayed side by side on the display screen, the device having a function of placing the mark between said two data.

5. The portable information terminal device according to claim 2,
the device having a function of dragging the operation element up and down on the display screen while the operation element being touched.

6. The portable information terminal device according to claim 5,
the device having a function of moving the mark in the direction that the operation element drags on the display screen.

7. The portable information terminal device according to claim 6,
when a data is displayed on the display screen, the device having a function of placing the mark directly above or below the data.

8. The portable information terminal device according to claim 6,
when two data are displayed side by side on the display screen, the device having a function of placing the mark between said two data.

9. The portable information terminal device according to claim 2
when the operation element reaches a predetermined position at the top of the display screen, the device having;
a function of stopping the operation element; and
a function of scrolling the data downward on the display screen.

10. The portable information terminal device according to claim 9,
if a data exists outside the top of the display screen, the device having a function of displaying the data existing outside on the display screen by the function of scrolling the data.

11. The portable information terminal device according to claim 2,
when the operation element reaches a predetermined position at the bottom of the display screen, the device having;
a function of stopping the operation element; and
a function of scrolling the data upward on the display screen.

12. The portable information terminal device according to claim 11,
if a data exists outside the bottom of the display screen, the device having a function of displaying the data existing outside on the display screen by the function of scrolling the data.

13. The portable information terminal device according to claim 2,
the device having a function of writing or adding a new data at the position where the mark is placed by releasing the touch from the operation element.

14. The portable information terminal device according to claim 3,
the device having a function of writing or adding a new data at the position where the mark is placed by releasing the touch from the operation element.

15. The portable information terminal device according to claim 4,
the device having a function of writing or adding a new data at the position where the mark is placed by releasing the touch from the operation element.

16. The portable information terminal device according to claim 5,
the device having a function of writing or adding a new data at the position where the mark is placed by releasing the touch from the operation element.

17. The portable information terminal device according to claim 9,
the device having a function of writing or adding a new data at the position where the mark is placed by releasing the touch from the operation element.

18. The portable information terminal device according to claim 11,
the device having a function of writing or adding a new data at the position where the mark is placed by releasing the touch from the operation element.

19. The portable information terminal device according to claim 13, the device having;
a function of displaying a keyboard on the display screen by releasing the touch from the operation element; and
a function of writing or adding a new data with the keyboard at the position where the mark is placed.

16. The portable information terminal device according to claim 5,
the device having a function of moving the operation element or the mark to any position on the display screen or any position in the data on the display screen by dragging the operation element.
